(19) United States
(12) Patent Application Publication
(10) Pub. No.: US 2007/0067155 A1
(43) Pub. Date: Mar. 22, 2007

(54) Surface structure generation

(75) Inventors: W. Randolph Ford, Marriottsville, MD (US); David Gurzick, Frederick, MD (US); Mark Newman, Middletown, MD (US)

Correspondence Address: MANNAVA & KANG, P.C., 8221 Old Courthouse Road, Suite 104, Vienna, VA, 22182, US

(73) Assignee: Sonum Technologies, Inc.

(21) Appl. No.: 11/231,137

(22) Filed: Sep. 20, 2005

(51) Int. Cl. G06F 17/27

(52) U.S. Cl. 704/9

(57) ABSTRACT

A deep structure is received. A multistage, surface structure, generation process is used to determine one or more concepts, phrases, and words from the deep structure.

### TECHNICAL FIELD

This technical field relates generally to generating a surface structure from a deep structure.

### BACKGROUND

The study of artificial intelligence as it relates to human language has been concerned primarily with understanding human communication in the form of natural language. An additional area of study, however, is concerned with natural language generation. That is to say, how can we use a computer to generate a message in natural language from a concept or something analogous to a symbolic representation of a human thought. Success in creating a system with natural language generation capabilities would be useful in a variety of applications such as having computers speak to users while employing the variability of expression characteristic of human natural language generation, aiding people in writing routine documents where such documents follow structured or predictable content, recasting existing written text in natural language more easily understood by a subset of the population, and as a subsystem for a machine translation system.

Currently, there are some approaches employed for natural language generation. Canned text is one approach. In this approach, predetermined responses are listed in a system for use when specific, related events occur. An example of such a system is the speech heard when riding light rail and subway systems, where one hears “Doors closing!” Another example is the speech generated to accompany the use of a scanning system in a grocery store.

A second approach is template systems. In this approach, responses are created by using predetermined templates where specific content is varied. An example of such a system is the speech generated on menus a caller hears, for example, when calling a customer service center. The speech is varied based on the selection of the user.

These approaches may be appropriate for some applications but lack the ability to generate a message in natural language from many concepts or in a natural language form that may be used by different users.

### SUMMARY

According to an embodiment, a deep structure is received. A multistage, surface structure, generation process is used to determine one or more concepts, phrases, and words from the deep structure.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 illustrates a system, according to an embodiment;

FIG. 2A illustrates a data flow diagram for generating a surface structure, according to an embodiment;

FIG. 2B illustrates a data flow diagram for selecting a surface structure using a probability selector, according to an embodiment;

FIG. 3A illustrates a logical representation of entries in a data repository, according to an embodiment;

FIG. 3B illustrates a representation of word entries in the data repository, according to an embodiment;

FIG. 3C illustrates a representation of phrase entries in the data repository, according to an embodiment;

FIG. 3D illustrates a representation of concept entries in the data repository, according to an embodiment;

FIG. 4 illustrates a multi-stage, surface structure, generation process, according to an embodiment;

FIG. 5 illustrates examples of concept entries in the data repository, according to an embodiment;

FIG. 6 illustrates an example of a phrase entry in the data repository, according to an embodiment;

FIG. 7 illustrates examples of word entries in the data repository, according to an embodiment;

FIG. 8 illustrates examples of inputted communications, according to an embodiment;

FIG. 9 illustrates examples of frequency counts for words and phrases, according to an embodiment;

FIGS. 10A-B illustrate examples of word and phrase entries corresponding to the examples shown in FIGS. 8 and 9, according to an embodiment;

FIG. 11 illustrates a process for selecting a surface structure, according to an embodiment;

FIG. 12 illustrates examples of normalized probabilities for generated surface structures, according to an embodiment; and

FIG. 13 illustrates a computer system, according to an embodiment.

### DETAILED DESCRIPTION

For simplicity and illustrative purposes, the principles of the embodiments are described. However, one of ordinary skill in the art would readily recognize that the same principles are equally applicable to, and can be implemented in, all types of network systems, and that any such variations do not depart from the true spirit and scope of the embodiments. Moreover, in the following detailed description, references are made to the accompanying figures, which illustrate specific embodiments. Changes may be made to the embodiments without departing from the spirit and scope of the embodiments.

According to an embodiment, a surface structure generation system is provided that is operable to generate a surface structure from a deep structure. A deep structure includes an abstract underlying structure from which the actual form of a sentence is derived. A surface structure includes a structure that corresponds with the actual form of a sentence. The surface structure generation system is operable to retrieve words, phrases and concepts with the same or similar meaning from a language repository and generate new word, phrase and concept language patterns that could possibly occur in a targeted language. In one embodiment, a probabilistic methodology is used to generate a surface structure having a same or similar derived root meaning from as the deep structure the surface structure is generated from.

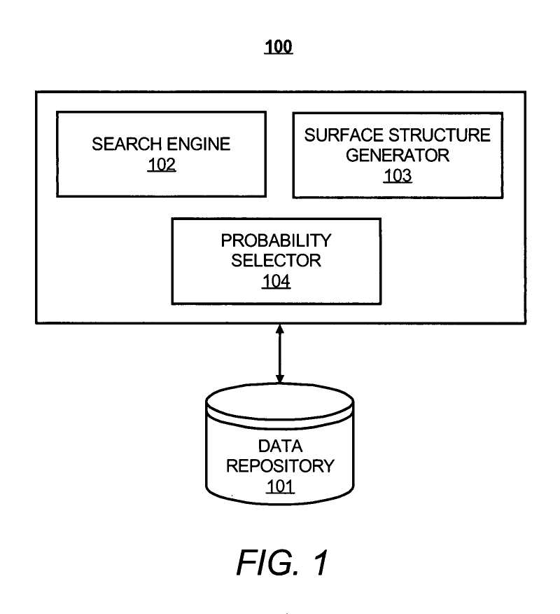

FIG. 1 illustrates a surface structure generation system 100 according to an embodiment that is operable to generate a surface structure from a deep structure. The system 100 includes a data repository 101, a search engine 102, a surface structure generator 103, and a probabilistic selector 104.

The data repository 101 stores concepts, phrases, and words. The data repository stores semantic values for the concepts, phrases, and words and the corresponding concepts, phrases, and words. The deep structure, for example, comprises a reduced, representation of language text, wherein semantic values, including semantic values stored in the data repository 101, are operable to be used to reduce the language text to the representation. Generation of the deep structure may be performed through a multi-stage reduction process reducing the language text to concept values, reducing the concept values to phrase values, and reducing the phrase values to word values, as described in detail below.

The data repository 101 contains a knowledge base of words, phrases, and concepts for a specific language. Each of the entries in the data repository 101 may be identified by a designated semantic value. A semantic value is a representation of data in an entry, such as a representation of individual words, phrases, or concepts. Each semantic value is unique for “nonequivalent” entries. For example, the words “car” and “automobile” may be represented by the same word semantic value, and “car” and “motorcycle” may be represented by different word semantic values. A determination of “equivalent” and “nonequivalent” entries may be predetermined, and tables or other data structures may be used to store all “equivalent” entries under the same semantic value.

The search engine 102 is operable to retrieve at least one of concepts, phrases, and words from the data repository 101 associated with a deep structure. In one embodiment, the search engine 102 uses semantic values from a deep structure to identify and retrieve one or more of concepts, phrases, and words from the data repository 101 to generate surface structures associated with the deep structure.

The surface structure generator 103 is operable to generate a plurality of surface structures from concepts, phrases, and words retrieved from the data repository 101 by the search engine 102. The probabilistic selector 104 is operable to select one of the plurality of surface structures based on a probability analysis of the plurality of surface structures. The probabilistic selector 104 is also operable to select the concepts, phrases and words used to generate the plurality of surface structures based on a probability analysis. The probability analysis, for example, is based on speech patterns of a particular user. For example, the probability analysis is performed to select one or more of the concepts, the phrases, the words and the surface structure that the particular user would likely use. Probabilities may be determined based on an analysis of the speech patterns of the user or using other conventional methods.

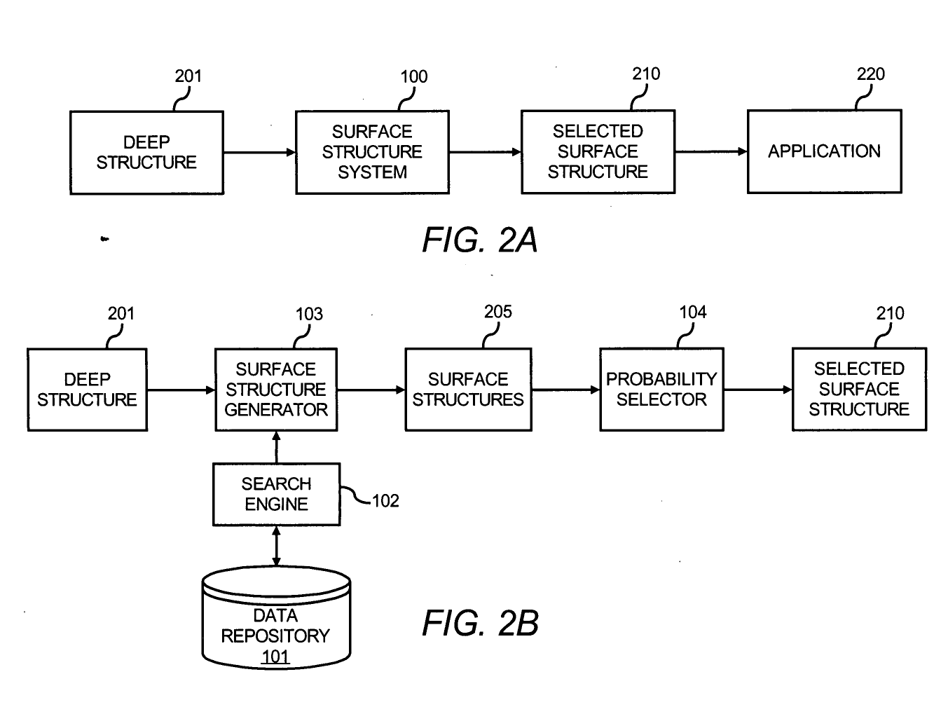

FIG. 2A illustrates a data flow diagram, according to an embodiment, representing the output of the system 100 shown in FIG. 1, and using the output as input to an application 220. The input to the system 100 is a deep structure 201.

According to an embodiment, the deep structure 201 is generated using a multi-stage reduction process reducing the language text to concept values, reducing the concept values to phrase values, and reducing the phrase values to word values. The multi-stage reduction process is described in detail in U.S. patent application Ser. No. 10/390,270, entitled “Natural Language Processor” and assigned to the same assignee as the present application, and which is incorporated by reference in its entirety. In one example, the deep structure 201 includes semantic values and these semantic values are used to generate surface structures associated with the deep structure.

The system 100 generates a plurality of surface structures from the deep structure 201. From the plurality of surface structures, the system 100 could select all surface structures, or either select the best choice or most probabilistic surface structure based on probability analysis. In one embodiment, the most probabilistic surface structures is selected, for example, using a probability analysis, based on speech patterns of a particular user. The selected surface structure is shown as 210. Based on the probability analysis, the selected surface structure 210 is determined to be the surface structure most likely to be spoken or used by a particular user. The selected surface structure 210 may be used as input to an application 220, such as a software application on the user's computer system. For example, the surface structure may be used as input to a speech generator that converts the surface structure to speech. In another example, the system 100 is used to generate a surface structure for different levels of readability. For example, a technical document is converted by the system 100 to a readability level for a 7^{th} grader rather than a graduate student. Other types of applications may also use the output of the system 100. Furthermore, system 100 may take the output of an application, not shown, and generate a surface structure from the output of an application. For example, text is received from an unknown author. The system 100 is used to determine the probability that the text is from one of several known authors.

FIG. 2B illustrates a data flow diagram, according to an embodiment, illustrating the generation of the selected surface structure 210. The deep structure 201 is received by the system 100. The search engine 102 identifies and retrieves one or more of concepts, phrases, and words matching semantic values in the deep structure 201 from the data repository 101, and the surface structure generator 103 generates surface structures 203 from the words phrases and concepts. The probabilistic selector 104 is operable to select one of the surface structures 205, shown as selected surface structure 210, based on a probability analysis of the plurality of surface structures. The probability analysis, for example, is based on speech patterns of a particular user.

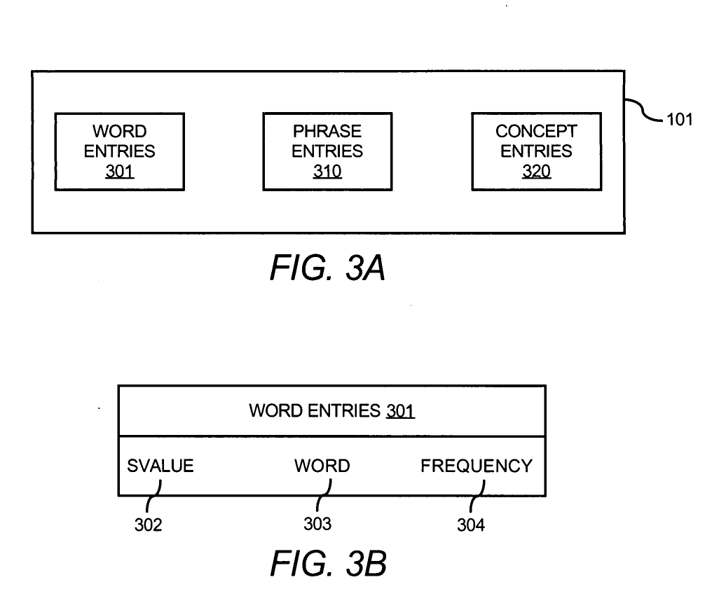

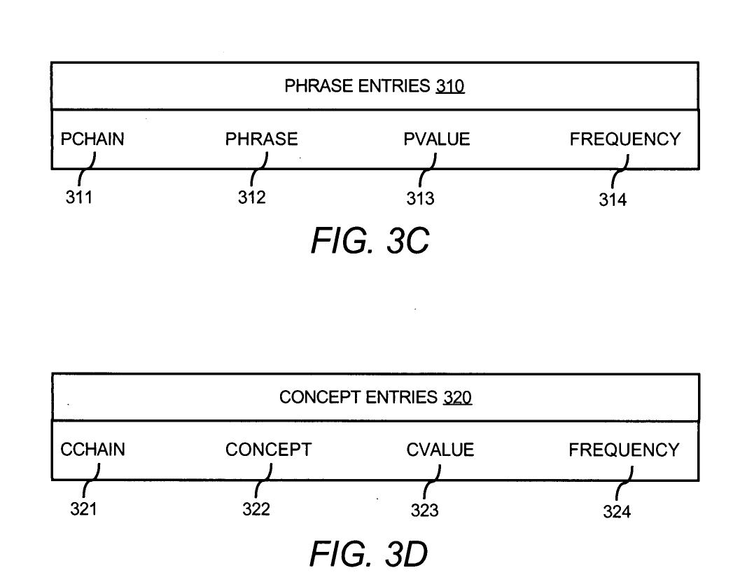

In one embodiment, the surface structure generator 103 generates the surface structures 205 through a multi-stage surface structure generation process. The process includes selecting concepts, phrases and words matching semantic values in the deep structure 201. In order to select concepts, phrases and words matching semantic values in the deep structure 201 the data repository 101 stores entries for concepts, phrases and words. FIG. 3A illustrates a logical representation of the entries for words 301, phrases 310 and concepts 320 stored in the data repository 101. A representation of word entries 301, phrases entries 310, and concept entries 320 is shown in FIGS. 3B-3D, respectively.

As shown in FIG. 3B, each of the word entries 301, for example, includes an svalue attribute 302, a word attribute 303, and a frequency attribute 304. The svalue attribute 302 includes the assigned semantic value for each word stored in the repository 101. The word attribute 303 includes the stored words. Words determined to have the same meaning are assigned the same semantic value. The words are used by the surface structure generator 103 shown in FIG. 1 to create the surface structures 205 shown in FIG. 2B. The frequency attribute 304 is the frequency of use for a word in the data repository 101. For example, the frequency attribute 304 includes the number of times the word was counted during corpus training and frequency analysis of inputted communications. The probability selector 104 shown in FIG. 1 uses frequency values for the frequency attribute to determine which surface structure, such as the selected surface structure 210 shown in FIG. 2B, to select from the generated surface structures 205. Each entry in the word entries 301, for example, includes an svalue, one or more words corresponding to the svalue, and the frequency for the one or more words.

In addition to a collection of words in the word entries 301, the repository 101 contains a collection of phrases that can be recognized in inputted communications. Phrases contained in the repository 101, for example, were identified as a result of corpus training and frequency analysis of inputted communications. As shown in FIG. 3C, each of the phrase entries 310, for example, includes a pchain attribute 311, a phrase attribute 312, a pvalue attribute 313, and a frequency attribute 314. The pchain attribute 311 includes a collection of semantic symbols that corresponds to the words from the word entries 301. The phrase attribute 312 includes phrases. The phrases may not be used in the surface structure generation process and instead may be used to provide a visual indication as to what the phrase is as opposed to looking up each semantic svalue in a pchain field. The pvalue attribute 313 includes the assigned semantic value of each phrase in the data repository 101. Phrases determined to have the same meaning are assigned the same semantic value. The frequency attribute 314 is the frequency of use for a phrase in the data repository 101. For example, the frequency attribute 314 includes the number of times the phrase was counted during corpus training and frequency analysis of inputted communications. The probability selector 104 shown in FIG. 1 uses frequency values for the frequency attribute 314 to determine which surface structure, such as the selected surface structure 210 shown in FIG. 2B, to select from the generated surface structures. 205.

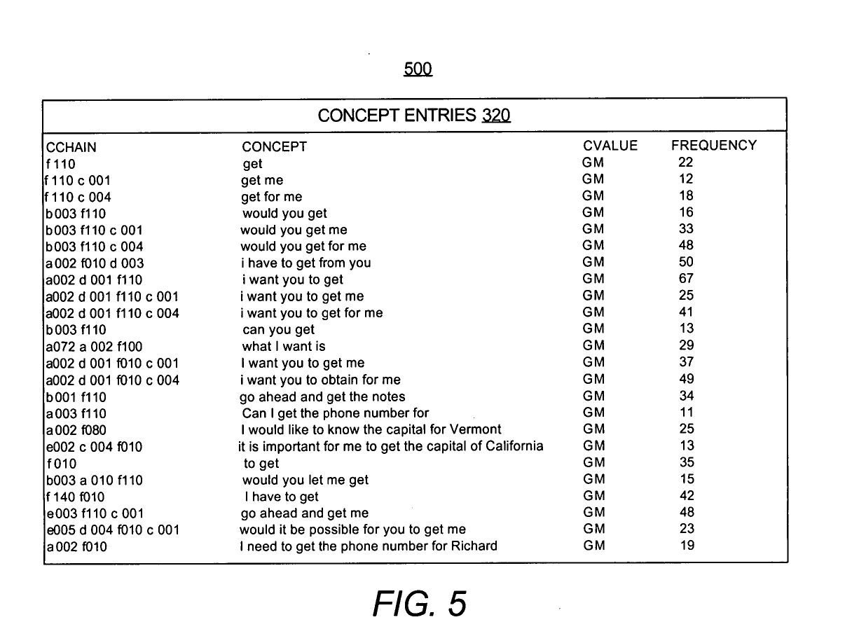

The data repository 101 also includes a collection of concepts that can be recognized in inputted communications. Concepts contained in the data repository 101, for example, are identified as a result of corpus training and frequency analysis of inputted communications. FIG. 3D illustrates attributes in the concept entries 320. The attributes include a cchain attribute 321, a concept attribute 322, a cvalue attribute 323, and a frequency attribute 324. The cchain attribute 321 includes a collection of semantic values that corresponds to the phrases in the phrase entries 310 in the data repository 101. Concepts attribute 322 includes concepts in text. It will be apparent to one of ordinary skill in the art that text, such as shown in FIG. 5 and text that would be under concepts attribute 322 shown in FIG. 3D may not be in the concepts table. The text is provided for purposes of describing the embodiments and the concepts table, in one embodiment, may include semantic values for performing a look-up on a concept semantic value in a deep structure to find one or more corresponding phrase semantic values. Frequency values may also be provided. The cvalue attribute 323 includes the assigned semantic value for each concept. Concepts determined to have the same meaning are assigned the same semantic value. The frequency attribute 324 is the frequency of use for a concept in the data repository 101. For example, the frequency attribute 324 includes the number of times the concept was counted during corpus training and frequency analysis of inputted communications. The probability selector 104 shown in FIG. 1 uses frequency values for the frequency attribute 324 to determine which surface structure, such as the selected surface structure 210 shown in FIG. 2B, to select from the generated surface structures 205.

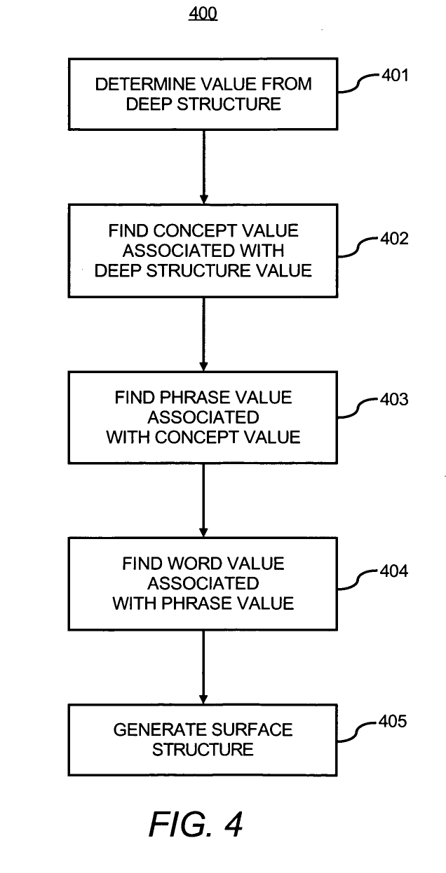

FIG. 4 illustrates a method 400 according to an embodiment for generating a surface structure. FIG. 4 is described with respect to FIGS. 1-3 by way of example and not limitation. At step 401, the system 100 determines a semantic value from the deep structure 201 shown in FIG. 2B. The deep structure 201, for example, includes semantic values generated from the multi-stage reduction system described in U.S. patent application Ser. No. 10/390,270, entitled “Natural Language Processor”, previously incorporated by reference. For example, the multi-stage reduction system reduces the natural language input of “I would like to know what time it is?” to semantic values “GM W6 B3” which is the deep structure 201 in this example.

The system 100 parses the deep structure 201 to identify each semantic value “GM”, “W6” and “B3”. For each semantic value the search engine 102 shown in FIG. 2B searches the concept entries 320 shown in FIG. 3D. For example, the semantic value “GM” is determined at step 401. At step 402, the search engine 102 shown in FIG. 2B searches the concept entries 320 shown in FIG. 3D for a value for the cvalue attribute 323 matching the semantic value “GM”.

The surface structure generator 103 identifies a match based on the results of the search performed by the search engine 102. Then, step 403 is performed. FIG. 5 illustrates an example of entries 500 that are concept entries 320 of FIG. 3D. The search engine 102, for example, identifies entries 500 shown in FIG. 5 that match the semantic value “GM” from the deep structure 201. Each entry includes a cchain value, a concept, a cvalue semantic value, and a frequency value. The concepts in the entries 500 were determined to have the same meaning and thus have the same cvalue semantic value. Matching cvalue semantic values are identified, and at step 403, the surface structure generator 103 instructs the search engine 102 to search for pvalue semantic values in the phrase entries 310 shown in FIG. 2C matching each cchain semantic value in the entries 500.

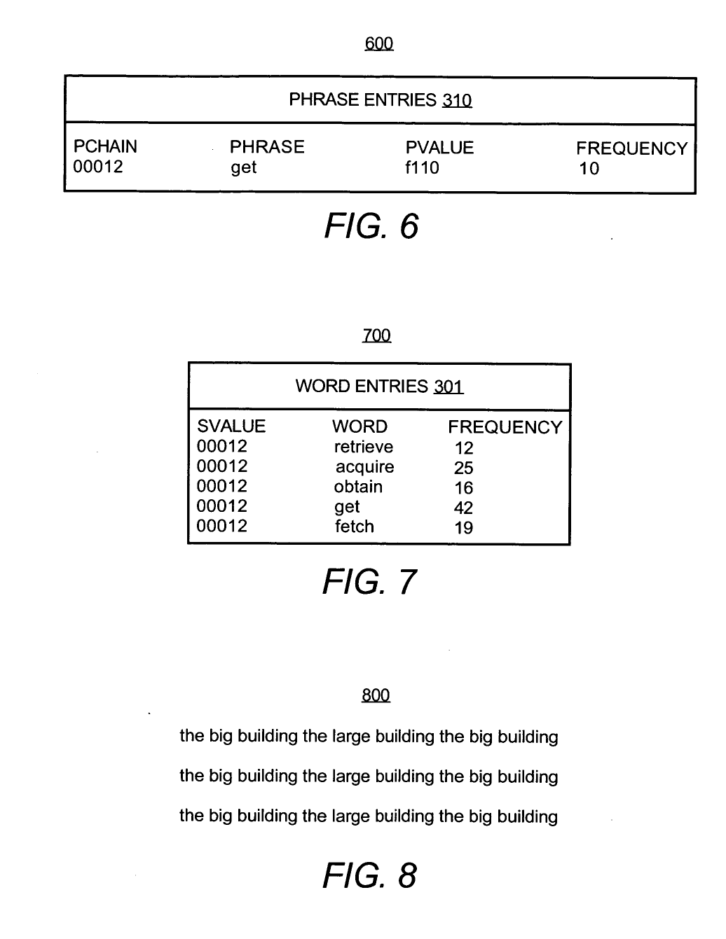

For example, at step 403, the search engine 102 searches the phrase entries 310 for a pvalue semantic value of “f110”. FIG. 6 illustrates an example of a phrase entry including a pvalue semantic value of “f110”. The corresponding phrase is “get” and the corresponding pchain value is “00012”. This step is repeated for each cchain semantic value in the entries 500.

A matching pchain semantic value is identified at step 403. At step 404, the search engine 102 searches the word entries 301 of FIG. 3B for svalue semantic values matching the pchain value for each phrase entry identified at step 404. For example, the search engine 102 searches the word entries 301 for a svalue semantic value “00012”. FIG. 7 illustrates entries 700, which are examples of word entries having an svalue semantic value “00012”. Each of the words in the entries 700 were determined to have the same meaning.

At step 405 a surface structure is generated for the deep structure value identified at step 401. The surface structure, for example, includes the words from the word entries identified at step 404. The words are determined for each phrase identified at step 403 associated with the concept value identified at step 402. Also, the method 400 is repeated for each semantic value in the deep structure 201, such as the semantic values “GM”, “W6” and “B3”, to generate the surface structures 205 of FIG. 2B.

A concept semantic value, such as a cvalue semantic value, a phrase semantic value, such as a pvalue semantic value, and a word semantic value, such as an svalue semantic value may not be found for each semantic value in the deep structure. In that situation, the system 100 may generate an alert indicating that a match was not found.

The method 400 describes a three-stage surface structure generation process including determining associated concepts, phrases and words for a deep structure. The method 400 may be performed by the system 100 shown in FIG. 1. For each semantic value in the deep structure 201, the surface structure generator 103 and the search engine 102 attempt to identify all concepts in the data repository 101 that have the same meaning as the inputted semantic value. For each concept, the surface structure generator 103 and the search engine 102 attempt to identify all phrases in the data repository that have the same meaning, and for each phrase, all the words that have the same meaning. This process is repeated for each semantic value in the deep structure 201 to generate multiple surface structures 205. The surface structures 205, for example, are different combinations of the words associated with the identified concepts and phrases. Then, the probability selector 104 selects one of the surface structures 205 based on a probabilistic analysis. The selected surface structure may be used to control an application.

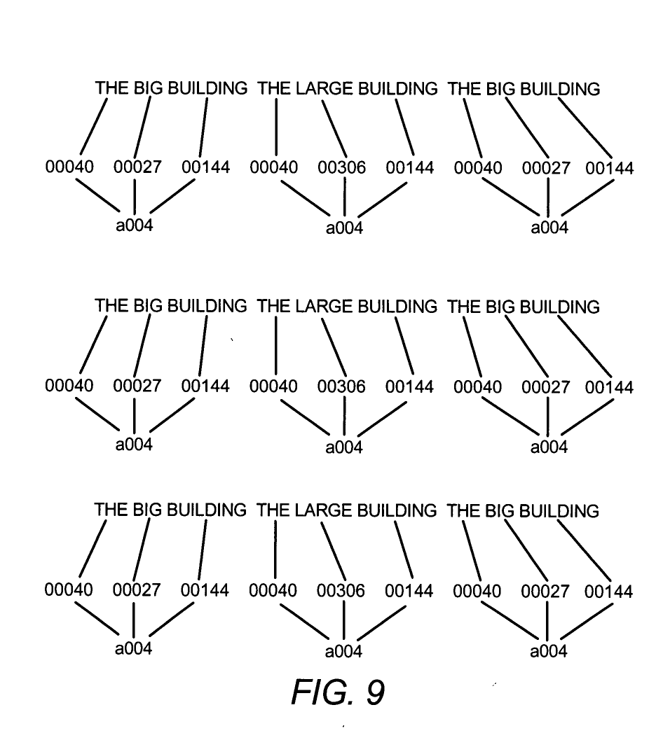

The probabilistic analysis performed by the probability selector 104 may include using frequency values from the entries identified in the method 400 to select a surface structure. FIGS. 8-10A-B illustrate generating frequency values for words and phrases, according to an embodiment. Frequency values for concepts may be determined using the same techniques described below. For example, a corpus training tool receives inputted communications. The inputted communications may be representative of a user's communications, which may be verbal or written, or representative of communications of a group of users. FIG. 8 illustrates an example of phrases 800 used as inputted communications. The training tool assigns the words svalue semantic values and the phrases pvalue semantic values. FIG. 9 illustrates examples of the semantic values. For example, “the”, “big”, and “building” are each assigned svalue semantic values “00040”, “00027”, “00144”, respectively. The phrases “the big building” and “the large building” are each assigned a pvalue semantic value of “0004”. Phrases having similar meanings are assigned the same semantic values, and the same words, which may be used in different phrases, are assigned the same semantic values.

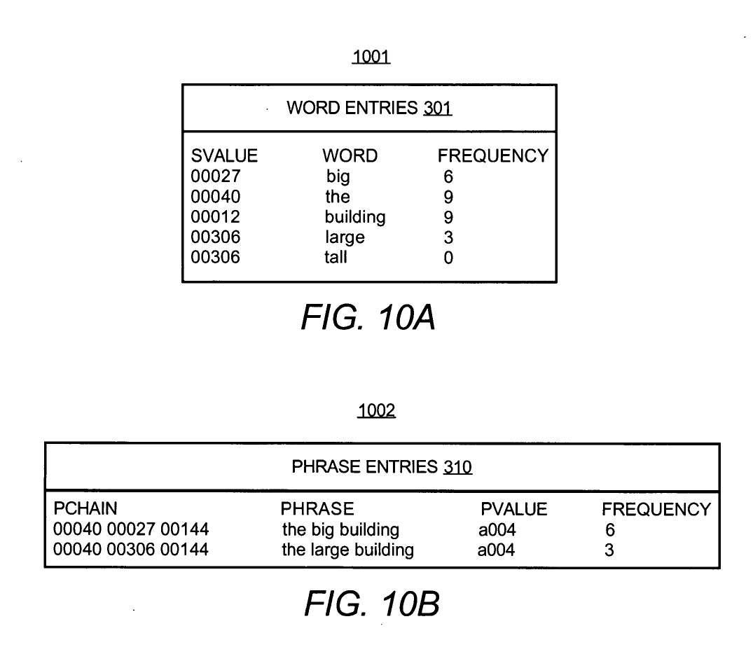

FIGS. 10A-B illustrate examples of word entries 1001 and phrase entries 1002 generated by the training tool for the inputted communications 800 shown in FIG. 8 and including frequencies determined by the training tool. The word entries 1001 and the phrase entries 1002 may be subsets of the word entries 301 and the phrase entries 310 shown in FIGS. 3B and 3C, respectively.

In one embodiment, the frequencies shown in FIGS. 10A and 10B are based on a frequency count of the words and phrases, such as a count of the words and phrases shown in FIG. 9. For example, in FIG. 10A “big” is counted 6 times in the inputted communication 800. As shown in FIG. 10B, the phrases having similar meaning are counted 9 times.

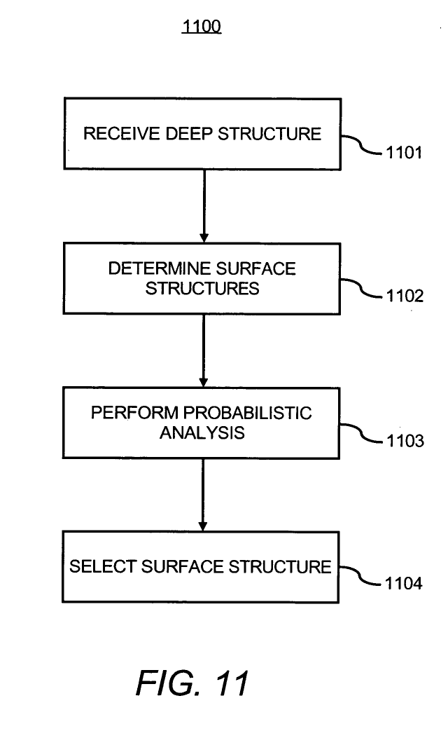

The frequencies described above may be used to select a surface structure from a plurality of generated surface structures. FIG. 11 illustrates a method 1100 for selecting a surface structure using a probabilistic analysis from a plurality of surface structures. The method 1100 is described with respect to FIGS. 1-10A-B by way of example and not limitation.

At step 1101, the deep structure 201 is received, such as shown in FIG. 2B. At step 1102, the surface structure generator 103 generates surface structures 205 using, for example, the multi-stage generation process described above. At step 1103, the probability selector 104 performs a probabilistic analysis to select at least one the concepts, words and phrases for the determined surface structures. The probabilistic analysis to select the concepts, words and phrases for the surface structures may be performed at the same time as step 1102, such as while the surface structures are generated. At step 1104, the probability selector 104 may perform a probabilistic analysis to select one of the surface structures generated that is likely representative of a surface structure that would have been generated by a user, such as in a verbal or written communication.

The probabilistic analysis performed at step 1103 may include analyzing the frequencies for concepts, phrases and words, and using a random number generator seed. Analyzing frequencies may include determining frequency counts, such as shown in FIGS. 10A and 10B for the words and phrases shown in FIGS. 8 and 9.

For example, using the multi-stage surface structure generation process shown in FIG. 4 and described above, the system 100 generates the following surface structures from the phrase “a004” shown in FIGS. 9 and 10A-B. The generated surface structures include:
a004->00040 00027 00144-> the big building
a004->00040 00306 00144-> the large building
a004->00040 5 00144-> the tall building

The probability selector 104 shown in FIG. 2B then applies probabilities to the generated surface structures based upon their frequency counts stored in the data repository 101. The frequencies, which are the frequency counts in this embodiment, are shown in parentheses below for each svalue semantic value.
a004->00040(9)00027(6)00144(9)-> the big building
a004->00040(9)00306(3)00144(9)-> the large building
a004->00040(9)5(1)00144(9)->the tall building

Next, the probability selector 104 normalizes the probabilities for each generated surface structure. An example of normalizing the probabilities is shown below.
9*6*9=486=0.6*810
9*3*9=243=0.3*810
9*1*9=81=0.1*810

This yields a total sum of 810 (486+243+81). This number is used as the range for generating a random number, such as a range of 1-810.

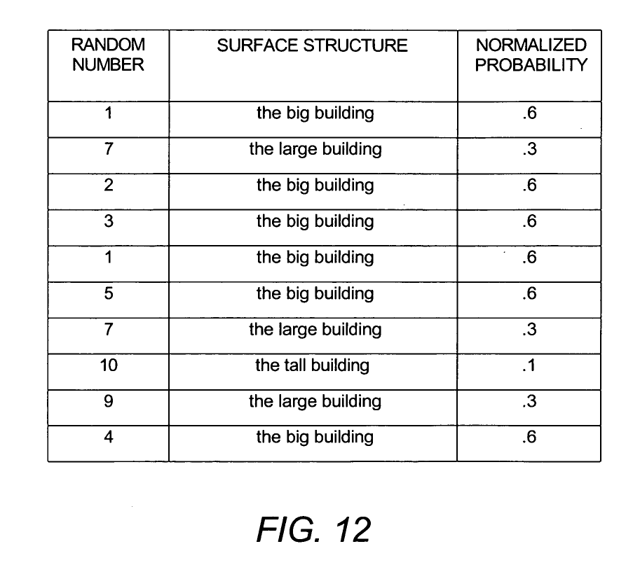

Using random numbers generated in the range and the normalized probabilities, the probability selector 104 determines which surface structure to select. For example, the probabilistic selector 104 system 100 perform a probabilistic analysis 10 times. It will be apparent that the analysis may be performed more than 10 times or less than 10 times. The probabilistic selector 104 generates a random number in the range 10 times. For example, for a range of 1-10, the following random numbers are generated: 1, 7, 2, 3, 1, 5, 7, 10, 9, and 4. Some numbers in the range may not be generated, such as 6 and 8 in this example. FIG. 12 illustrates the surface structures that would be returned based on these random numbers and their corresponding normalized probabilities. The system 100 may support the notion of null recurrent words and phrases. With respect to the probabilistic algorithm, words and phrases with a frequency count of 0 are treated with frequency count of 1. Even though a word or phrase might have a frequency count of zero, they are valid constructions so they are given a frequency count of 1 and may be used in generating a surface structure. However, the system 100 can be configured to treat words and phrases with a frequency count of zero. In this embodiment, the word or phrase having a frequency count of zero would never be selected by the system 100 to generate the plurality of surface structures.

Based on the probability selector 104 returning a random number of 1, the surface structure “the big building” is selected from the collection of surface structures. Since “the big building” surface structure has an assigned probability of 0.6, all random numbers returned in the range 1-6 inclusive will select “the big building” surface structure. Random numbers in range 7-9 inclusive will select “the large building” surface structure. Random number 10 will select “the tall building” surface structure.

The ability to generate a surface structure in a targeted language based on frequency analysis of an inputted corpus is useful for many applications, including data mining applications. For example, let's assume that we had a corpus from a known source, such as a particular user. Using a corpus training tool with the known corpus assigns frequency counts to the words, phrases, and concepts in the data repository 101. In other words, the data repository would be trained the way that the particular user communicates. Now, an inputted communication from an unknown source may be compared against the data repository 101 based, for example, on probabilistic speech pattern, to determine whether the unknown source is the particular user.

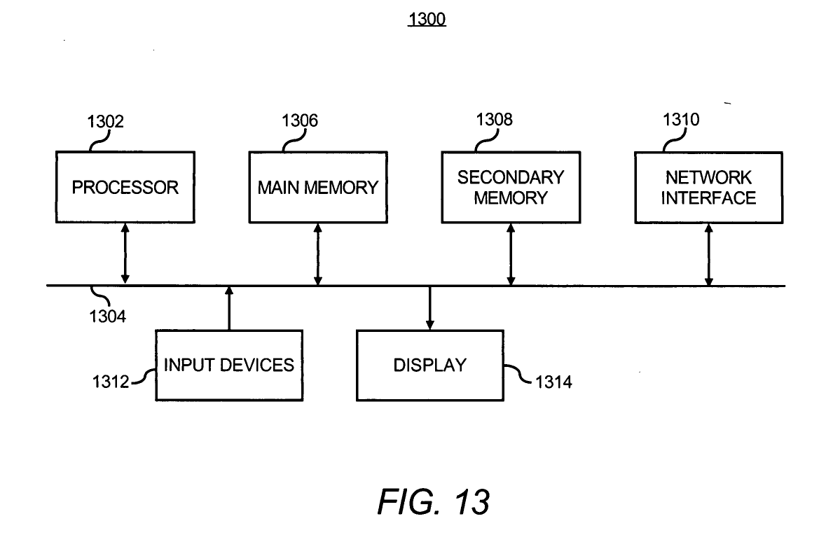

FIG. 13 illustrates a block diagram of a general purpose computer system 1300 that may be used as a hardware platform for the system 100 shown in FIG. 1, according to an embodiment. It will be apparent to one of ordinary skill in the art that a more sophisticated computer system may be used. Furthermore, components may be added or removed from the computer system 1300 to provide the desired functionality.

The computer system 1300 includes one or more processors, such as processor 1302, providing an execution platform for executing software. Commands and data from the processor 1302 are communicated over a communication bus 1306. The computer system 1300 also includes a main memory 1306, such as a Random Access Memory (RAM), where software may be resident during runtime, and a secondary memory 1308. The secondary memory 1308 includes, for example, a hard disk drive 1310 and/or a removable storage drive 1312, representing a floppy diskette drive, a magnetic tape drive, a compact disk drive, etc., or a nonvolatile memory where a copy of the software may be stored. The secondary memory 1308 may also include ROM (read only memory), EPROM (erasable, programmable ROM), EEPROM (electrically erasable, programmable ROM). The removable storage drive 1312 reads from and/or writes to a removable storage unit 13113 in a well-known manner.

The computer system 1300 may include user interfaces comprising one or more input devices 1328, such as a keyboard, a mouse, a stylus, and the like. The display adaptor 1322 interfaces with the communication bus 1306 and the display 1320 and receives display data from the processor 1302 and converts the display data into display commands for the display 1320. The input devices 1328, the display 1320, and the display adaptor 1322 are optional. An administrator console, such as the console 421 shown in FIG. 4, may be used as a user interface. A network interface 1330 is provided for communicating with other computer systems.

One or more of the steps of the methods 400 and 1100 may be implemented as software embedded on a computer readable medium, such as the memory 1306 and/or 1308, and executed on the computer system 1300, for example, by the processor 1302.

The steps may be embodied by a computer program, which may exist in a variety of forms both active and inactive. For example, they may exist as software program(s) comprised of program instructions in source code, object code, executable code or other formats for performing some of the steps. Any of the above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. A method comprising:
receiving a deep structure;
determining at least one of (1) one or more concepts, (2) one or more phrases, and (3) one or more words from at least one value in the deep structure; and
determining at least one surface structure from the determined at least one of (1) one or more concepts, (2) one or more phrases, and (3) one or more words from at least one value in the deep structure.

2. The method of claim 1, wherein determining at least one of (1) one or more concepts, (2) one or more phrases, and (3) one or more words from at least one value in the deep structure further comprises:
identifying the at least one value in the deep structure;
searching a data repository for a concept value associated with the at least one is value; and
retrieving the concept value associated with the at least one value in response to identifying the concept value associated with the at least one value from the data repository.

3. The method of claim 2, further comprising:
searching the data repository for at least one phrase value associated with the retrieved concept value; and
retrieving the at least one phrase value associated with the concept value.

4. The method of claim 3, further comprising:
searching the data repository for at least one word value associated with the retrieved at least one phrase value; and
retrieving at least one word associated with the at least one phrase value.

5. The method of claim 4, wherein determining at least one surface structure further comprises:
determining the at least one surface structure from the at least one word.

6. The method of claim 1, wherein determining at least one of (1) one or more concepts, (2) one or more phrases, and (3) one or more words from at least one value in the deep structure further comprises:
determining the (1) one or more concepts, (2) one or more phrases, and (3) one or more words from the at least one value in the deep structure; and
determining at least one surface structure further comprises determining the at least one surface structure from the determined (1) one or more concepts, (2) one or more phrases, and (3) one or more words.

7. The method of claim 6, further comprising:
performing a probabilistic analysis to select at least one of the determined (1) one or more concepts, (2) one or more phrases, and (3) one or more words for generating the at least one surface structure.

8. The method of claim 7, wherein the probabilistic analysis determines a probability that a particular user would use the selected (1) one or more concepts, (2) one or more phrases, and (3) one or more words for generating the at least one surface structure.

9. The method of claim 8, further comprising:
performing a probabilistic analysis to select one surface structure from a plurality of surface structures generated from the determined (1) one or more concepts, (2) one or more phrases, and (3) one or more words.

10. The method of claim 2, wherein identifying the at least one value in the deep structure further comprises:
identifying at least one encoded string value from the received deep structure, wherein the deep structure comprises a reduced, encoded representation of language text.

11. A method comprising:
determining a plurality of values from a deep structure;
for each of the plurality of values
searching a data repository for at least one concept value associated with the value from the deep structure;
identifying the at least one concept value from the data repository, searching the data repository for at least one phrase value associated with the at least one phrase value; and
identifying the at least one phrase value from the data repository, searching the data repository for at least one word associated with the at least one phrase value; and
generating a surface structure from (1) the at least one concept value, (2) the at least one phrase value, and (3) the at least one word.

12. A probabilistic method of determining a surface structure from a deep structure, the method comprising:
receiving a deep structure;
determining a plurality of surface structures from the deep structure; and
performing a probabilistic analysis on each surface structure to select a surface structure from the plurality of surface structures.

13. The method of claim 12, wherein performing a probabilistic analysis on each surface structure further comprises:
determining frequency counts for words;
determining probabilities for each surface structure based on frequency counts for words in each surface structure; and
normalizing the probabilities.

14. The method of claim 13, further comprising:
determining a range of numbers;
assigning a subset of the range of numbers to each surface structure based on the normalized probability for the surface structure, wherein surface structures with higher normalized probabilities have greater amounts of numbers in their subsets;
randomly generating one of the numbers in the range;
determining the surface structure associated with the subset including the randomly generated number; and
selecting the surface structure.

15. The method of claim 13, wherein determining frequency counts for words further comprises:
determining frequency counts for words based on speech patterns for a particular user.

16. The method of claim 12, wherein performing a probabilistic analysis on each surface structure to select a surface structure from the plurality of surface structures further comprises:
assigning probabilities to each surface structure based on speech patterns for a particular user; and
selecting a surface structure based on the assigned probabilities.

17. The method of claim 16, wherein selecting a surface structure based on the assigned probabilities further comprises:
weighting each surface structure, such that surface structures with higher probabilities have higher weights; and
substantially randomly selecting the surface structure, wherein surface structures with higher weights are more likely to be selected.

18. The method of claim 12, wherein determining a plurality of surface structures from the deep structure further comprises:
using a multi-stage generation process operable to determine each surface structure from at least one of concepts, phrases, and words associated with the deep structure.

19. The method of claim 18, wherein using a multi-stage generation process further comprises:
determining a plurality of values from the deep structure;
for each of the plurality of values
searching a data repository for at least one concept value associated with the value from the deep structure;
in response to identifying the at least one concept value from the data repository, searching the data repository for at least one phrase value associated with the at least one phrase value; and
in response to identifying the at least one phrase value from the data repository, searching the data repository for at least one word value associated with the at least one word value; and
generating the surface structure from at least one of (1) the at least one concept value, (2) the at least one phrase value, and (3) the at least one word value.

20. The method of claim 18, further comprising:
performing a probabilistic analysis to select the concepts, the phrases and the words.

21. A surface structure generation system comprising:
a data repository storing concepts, phrases, and words;
a search engine operable to retrieve at least one of concepts, phrases, and words from the data repository associated with a deep structure;
a surface structure generator operable to generate a plurality of surface structures from at least one of concepts, phrases, and words retrieved from the data repository that are associated with the deep structure.

22. The surface structure generation system of claim 21, further comprising:
a probabilistic selector operable to select at least one of the concepts, the phrases, and the words from the data repository based on a probability analysis.

23. The surface structure generation system of claim 22, wherein the probability analysis comprises selecting the at least one of the concepts, the phrases, and the words based on probabilities that a particular user would use the selected at least one of the concepts, the phrases, and the words.

24. The surface structure generation system of claim 22, wherein the probability selector is further operable to select one of the plurality of surface structures based on a probability analysis.

25. The system of claim 21, wherein the data repository stores semantic values for the concepts, phrases, and words and the corresponding concepts, phrases, and words.

26. The system of claim 25, wherein the deep structure comprises a reduced, representation of language text, wherein the semantic values are operable to be used to reduce the language text to the representation.

27. The system of claim 26, wherein the representation is generated using a multi-stage reduction process reducing the language text to concept values, reducing the concept values to phrase values, and reducing the phrase values to word values.

28. The system of claim 21, wherein the surface structure generator operable to perform a multi-stage generation process to generate each surface structure; wherein the multi-stage generation process includes determining concept values from the deep structure, determining phrase values from the concept values, and determining words from the phrase values.

29. An apparatus comprising:
storage means for storing concepts, phrases, and words;
a search engine means for retrieving at least one of concepts, phrases, and words from the storage means that are associated with a deep structure; and
a surface structure generator means for generating a plurality of surface structures from data retrieved by the search engine means that is associated with the deep structure.

30. The apparatus of claim 29, further comprising:
selection means for performing a probability analysis to select at least one of the concepts, phrases, words, and one of the plurality of surface structures.
